(19) United States
(12) Patent Application Publication
(10) Pub. No.: US 2025/0193854 A1
(43) Pub. Date: Jun. 12, 2025

(54) GUARD PERIOD DETERMINATION METHODS AND APPARATUSES, COMMUNICATION DEVICES, AND STORAGE MEDIUMS

(71) Applicant: Beijing Xiaomi Mobile Software Co., Ltd., Beijing (CN)

(72) Inventor: Qun ZHAO, Beijing (CN)

(73) Assignee: Beijing Xiaomi Mobile Software Co., Ltd., Beijing (CN)

(21) Appl. No.: 18/844,804

(22) PCT Filed: Mar. 7, 2022
(86) PCT No.: PCT/CN2022/079618

§ 371 Date: Sep. 6, 2024

(51) Int. Cl. H04W 72/0446; H04L 27/26; H04W 72/1263

(52) U.S. Cl. CPC H04W 72/0446; H04L 27/2607; H04W 72/1263

(57) ABSTRACT

A guard period determination method includes: determining a time domain range corresponding to an uplink subband for uplink transmission in downlink slots; and determining a guard period before or in the time domain range.

### CROSS REFERENCE TO RELATED APPLICATIONS

This application is a National Phase of International Application No. PCT/CN2022/079618, filed on Mar. 7, 2022, the entire contents of which are incorporated herein by reference in their entireties.

### TECHNICAL FIELD

The present disclosure relates to the field of communication technologies, and in particular to guard period determination methods and apparatuses, communication devices, and computer-readable storage mediums.

### BACKGROUND

For a communication process between a terminal and a base station, in order to enable the terminal to support duplex communication, the base station may configure for the terminal an uplink (UL) subband for uplink data transmission in downlink (DL) slots, and may schedule uplink data transmission of the terminal in a time domain range corresponding to the UL subband. In the DL slot in which the UL subband is located, the terminal can also perform downlink data reception, so that duplex communication can be realized. However, the duplex communication based on the current way of configuring resources for the terminal has an impact on the communication effect.

### SUMMARY

To overcome the problems in the related arts, embodiments of the present disclosure provide guard period determination methods and apparatuses, communication devices, and non-transitory computer-readable storage mediums.

According to a first aspect of the embodiments of the present disclosure, there is provided a guard period determination method, performed by a terminal, and including: determining a time domain range corresponding to an uplink subband for uplink transmission in downlink slots; and determining a guard period before or in the time domain range.

According to a second aspect of the embodiments of the present disclosure, there is provided a guard period determination method, performed by a network device, and including: determining a time domain range, configured for a terminal, corresponding to an uplink subband for uplink transmission in downlink slots; and determining a guard period before or in the time domain range.

According to a third aspect of the embodiments of the present disclosure, there is provided a guard period determination apparatus, being applicable to a terminal, and including: a range determination module, configured to determine a time domain range corresponding to an uplink subband for uplink transmission in downlink slots; and a period determination module, configured to determine a guard period before or in the time domain range.

According to a fourth aspect of the embodiments of the present disclosure, there is provided a guard period determination apparatus, being applicable to a network device, and including: a range determination module, configured to determine a time domain range, configured for a terminal, corresponding to an uplink subband for uplink transmission in downlink slots; and a period determination module, configured to determine a guard period before or in the time domain range.

According to a fifth aspect of the embodiments of the present disclosure, there is provided a communication device, including: a processor; and a memory storing computer programs, where the computer programs, when executed by the processor, cause the processor to perform the guard period determination method(s) which is applicable to a terminal.

According to a sixth aspect of the embodiments of the present disclosure, there is provided a communication device, including: a processor; and a memory storing computer programs, where the computer programs, when executed by the processor, cause the processor to perform the guard period determination method(s) which is applicable to a network device.

According to a seventh aspect of the embodiments of the present disclosure, there is provided a non-transitory computer-readable storage medium, storing computer programs thereon, where the computer programs, when executed by a processor, cause the processor to perform the guard period determination method(s) which is applicable to a terminal.

According to an eighth aspect of the embodiments of the present disclosure, there is provided a non-transitory computer-readable storage medium, storing computer programs thereon, where the computer programs, when executed by a processor, cause the processor to perform the guard period determination method(s) which is applicable to a network device.

### BRIEF DESCRIPTION OF THE DRAWINGS

To describe the technical solutions of the embodiments of the present disclosure more clearly, the following briefly introduces the accompanying drawings required for describing the embodiments. Apparently, the accompanying drawings in the following description show only some embodiments of the present disclosure, and a person of ordinary skill in the art may still derive other drawings from these accompanying drawings without inventive efforts.

FIG. 1 is a schematic flowchart illustrating a guard period determination method according to an embodiment of the present disclosure.

FIGS. 2A to 2C are schematic diagrams illustrating several uplink subbands according to embodiments of the present disclosure.

FIG. 3 is a schematic flowchart illustrating a guard period determination method according to another embodiment of the present disclosure.

FIG. 4 is a schematic diagram illustrating a guard period according to an embodiment of the present disclosure.

FIG. 5 is a schematic flowchart illustrating a guard period determination method according to yet another embodiment of the present disclosure.

FIG. 6 is a schematic diagram illustrating a guard period according to another embodiment of the present disclosure.

FIG. 7 is a schematic flowchart illustrating a guard period determination method according to yet another embodiment of the present disclosure.

FIG. 8 is a schematic flowchart illustrating a guard period determination method according to an embodiment of the present disclosure.

FIG. 9 is a schematic flowchart illustrating a guard period determination method according to another embodiment of the present disclosure.

FIG. 10 is a schematic flowchart illustrating a guard period determination method according to yet another embodiment of the present disclosure.

FIG. 11 is a schematic flowchart illustrating a guard period determination method according to yet another embodiment of the present disclosure.

FIG. 12 is a schematic block diagram illustrating a guard period determination apparatus according to an embodiment of the present disclosure.

FIG. 13 is a schematic block diagram illustrating a guard period determination apparatus according to an embodiment of the present disclosure.

FIG. 14 is a schematic block diagram illustrating a device for determining a guard period according to an embodiment of the present disclosure.

FIG. 15 is a schematic block diagram illustrating a device for determining a guard period according to an embodiment of the present disclosure.

### DETAILED DESCRIPTION OF THE EMBODIMENTS

The following clearly and completely describes the technical solutions in the embodiments of the present disclosure with reference to the accompanying drawings in the embodiments of the present disclosure. Apparently, the described embodiments are some of the embodiments of the present disclosure rather than all of the embodiments. All other embodiments obtained by a person of ordinary skill in the art based on the embodiments of the present disclosure without creative efforts shall fall within the protection scope of the present disclosure.

The terms used in the present disclosure are for the purpose of describing a particular example only, and are not intended to limit the present disclosure. The singular forms such as “a,” “said,” and “the” used in the present disclosure and the appended claims are also intended to include multiple, unless the context clearly indicates otherwise. It will also be understood that as used herein, the term “and/or” is and includes any or all combinations of one or more of the associated listed items.

It is to be understood that although different information may be described using the terms such as “first,” “second,” “third,” etc. in the present disclosure, the information should not be limited to these terms. These terms are used only to distinguish the same type of information from each other. For example, the first information may also be referred to as the second information without departing from the scope of the present disclosure, and similarly, the second information may also be referred to as the first information. Depending on the context, as used herein, the wording “if” may be interpreted as “while . . . ” or “when . . . ” or “in response to a determination”.

For purposes of brevity and ease of understanding, the wordings “greater than” or “less than”, “higher than” or “lower than” are used herein to characterize size relationships. However, for those skilled in the art, it will be understood that the wording “greater than” covers the meaning of “greater than or equal to”, and the wording “less than” covers the meaning of “less than or equal to”. The wording “higher than” covers the meaning of “higher than or equal to”, and the wording “lower than” covers the meaning of “lower than or equal to”.

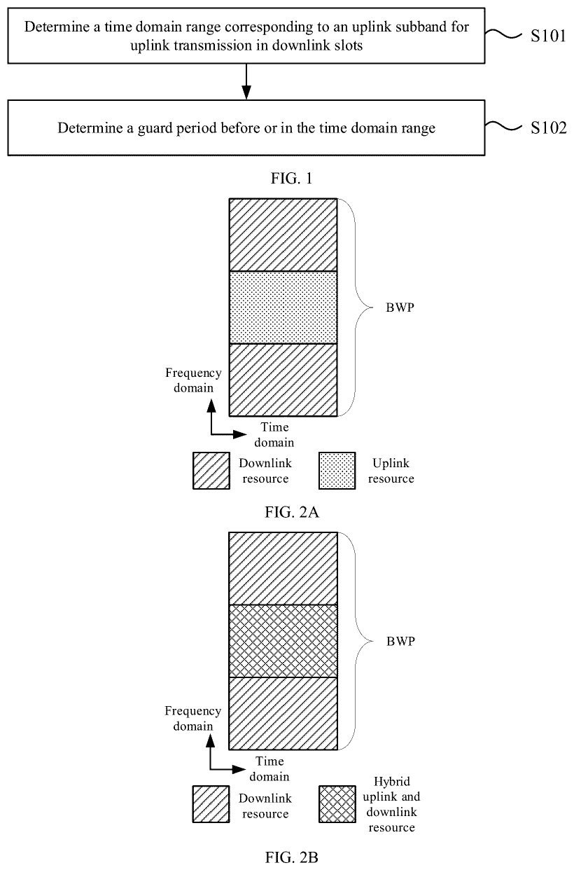

FIG. 1 is a schematic flowchart illustrating a guard period determination method according to an embodiment of the present disclosure. The guard period determination method in this embodiment can be applied to a terminal. The terminal includes, but is not limited to a mobile phone, a tablet computer, a wearable device, a sensor, an Internet of Things (IoT) device (such as narrow band Internet of Things (NB-IoT), machine type communication (MTC), enhanced machine type communication (eMTC) and other communication devices. The terminal may communicate with a network device. The network device includes, but is not limited to a network device (such as a base station, a core network, and the like) in a communication system such as a 4th generation (4G) communication system, 5G communication system, 6G communication system, etc.

As shown in FIG. 1, the guard period determination method may include the following steps, S101 and S102.

At step S101, a time domain range corresponding to an uplink (UL) subband for uplink transmission in downlink slots is determined.

At step S1102, a guard period is determined before or in the time domain range.

In an embodiment, duplex communication may be performed between the terminal and the network device, for example, full duplex communication may be performed, or half duplex communication may be performed.

The network device can configure the downlink (DL) slot for the terminal, and a frequency domain resource corresponding to the DL slot can include a frequency band or one or more bandwidth parts (BWPs) in a frequency band.

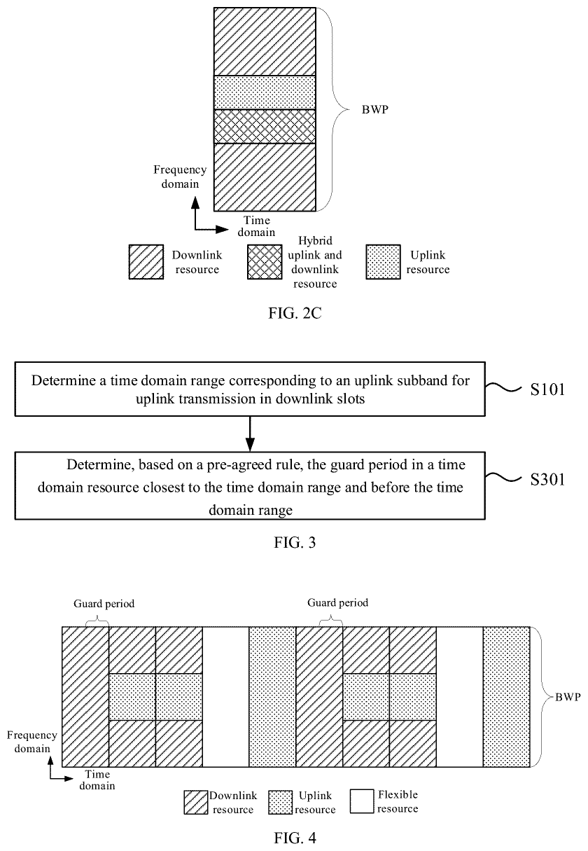

FIGS. 2A to 2C are schematic diagrams illustrating several uplink subbands according to embodiments of the present disclosure. In FIGS. 2A to 2C, the frequency domain resource corresponding to the uplink subband is shown as the “uplink resource”, the frequency domain resource used for downlink reception is shown as the “downlink resource”, and the overlap of the frequency domain resource corresponding to the uplink subband and the frequency domain resource used for downlink reception is shown as the “hybrid uplink and downlink resource”.

For example, the frequency domain resource corresponding to the DL slot includes a BWP.

In an embodiment, as shown in FIG. 2A, in the DL slot, the frequency domain resource corresponding to the uplink subband does not overlap with the frequency domain resource used for downlink reception.

In an embodiment, as shown in FIG. 2B, in the DL slot, the frequency domain resource corresponding to the uplink subband fully overlaps with the frequency domain resource used for downlink reception.

In an embodiment, as shown in FIG. 2C, in the DL slot, the frequency domain resource corresponding to the uplink subband partially overlaps with the frequency domain resource used for downlink reception.

The following embodiments are mainly illustrated in the case of the UL subband shown in FIG. 2A, but may pertain to FIGS. 2B and 2C.

In an embodiment, the DL slot configured by the network device to the terminal may be a plurality of consecutive DL slots, some of the plurality of consecutive DL slots may be configured with a UL subband, so that there is a downlink time domain resource for downlink data reception before the time domain range corresponding to the UL subband. The time domain range corresponding to the UL subband includes some or all of the time domain symbols in at least one DL slot.

For example, the time domain range corresponding to the UL subband starts from a first time domain symbol in a n-th (n is a positive integer) DL slot, and the time domain resource before the time domain range corresponding to the UL subband includes a (n−1)-th DL slot.

For example, the time domain range corresponding to the UL subband starts from a fifth time domain symbol in the n-th DL slot, and the time domain resource before the time domain range corresponding to the UL subband includes the first four time domain symbols in the n-th DL slot.

The time domain symbol is an orthogonal frequency division multiplexing (OFDM) symbol.

However, the terminal needs some time to switch the radio frequency (RF) device when switching from downlink reception to uplink transmission, otherwise it will bring interference to the uplink transmission. For example, the uplink transmission is performed after the downlink reception in the downlink time domain resource, if the switching of the RF device is not completed when the uplink transmission is required, the switching still needs to be completed before the terminal can perform the uplink transmission. This results in a delay in the timing of the uplink transmission, and thus causes interference to the uplink transmission.

According to the embodiments of the present disclosure, the terminal can determine the time domain range, configured by the network device, corresponding to the uplink subband for uplink transmission in downlink slots, and determine the guard period before or in the time domain range. The terminal does not expect to receive downlink data and does not transmit uplink data in the guard period, but may instead perform the switching from downlink reception to uplink transmission, so as to ensure that the terminal has completed the switching by the time the terminal needs to perform the uplink transmission. Thus, the terminal can perform the uplink transmission in a timely manner, and interference with the uplink transmission caused by the occurrence of a delay in the uplink transmission is avoided.

It is to be noted that the terminal and the network device may determine, based on a pre-agreed rule (for example, a protocol), the guard period before or in the time domain range, respectively, where the pre-agreed rule is known to both the network device and the terminal. Therefore, the terminal does not expect to receive downlink data and does not transmit uplink data in the guard period, and the network device does not expect to receive uplink data transmitted by the terminal and does not transmit downlink data to the terminal in the guard period. But the network device may receive uplink data transmitted by other terminals or transmit downlink data to other terminals in the guard period.

In an embodiment, the guard period is for the terminal to switch from downlink reception to uplink transmission. For example, the terminal may switch the RF device from being used for downlink reception to being used for uplink transmission in the guard period. However, it is to be noted that the operation performed by the terminal in the guard period is not limited to the switching from downlink to uplink, but other operations may be performed as required, such as performing operations such as compensating for the transmission delay (e.g., a delay from transmitting a signal by the network device to the reception of the signal by the terminal) between the network device and the terminal, performing timing synchronization, and the like.

In addition, it is to be noted that the UL subband applicable to the embodiments of the present disclosure includes an UL subband after a DL slot and adjacent to the DL slot, or an UL subband after a DL symbol and adjacent to the DL symbol. This is because the need to set the guard period is only necessary for the UL subband in this case.

FIG. 3 is a schematic flowchart illustrating a guard period determination method according to another embodiment of the present disclosure. As shown in FIG. 3, after step S101 of FIG. 1 is performed, the determining the guard period before or in the time domain range (S102) includes the following step S301.

At step S301, based on a pre-agreed/predetermined rule, the guard period is determined in a time domain resource closest to the time domain range and before the time domain range.

In an embodiment, the pre-agreed rule may be that the guard period is determined in the time domain resource closest to the time domain range and before the time domain range corresponding to the UL subband.

For example, the time domain range corresponding to the UL subband starts from a first time domain symbol in the n-th DL slot, and the time domain resource adjacent to the time domain range and before the time domain range corresponding to the UL subband includes the (n-1)-th DL slot, thus the guard period can be determined in the (n-1)-th DL slot.

In an embodiment, the guard period includes at least one time domain symbol in the time domain resource close to the time domain range, for example, from the last time domain symbol to the x-th to last time domain symbol in the time domain resource, where x is an integer greater than or equal to 1. Accordingly, the terminal may enter the guard period after performing the downlink reception in the time domain resource, and can perform the uplink transmission immediately after the guard period.

FIG. 4 is a schematic diagram illustrating a plurality of time domains containing two frame structures, each with a guard period, according to an embodiment of the present disclosure. In addition to the descriptions of the resources described with reference to FIGS. 2A-2C, FIG. 4 also includes a flexible resource.

As shown in FIG. 4, the frame structure is DDDSU (the structure is cycled twice in ten slots), where D represents a DL slot, S represents a flexible slot, and U represents an UL slot. This frame structure is shown twice. In three consecutive DL slots, the UL subband is configured in the second and third DL slots, and the time domain range corresponding to the UL subband starts from a first time domain symbol of the second DL slot.

The terminal, based on the pre-agreed rule, can determine the time domain resource, such as the first DL slot, which is closest to the time domain range and before the time domain range corresponding to the UL subband. Thus the terminal can determine the guard period in the first DL slot, for example, N (N is a positive integer and can be indicated by the network device) time domain symbols, close to the time domain range, in the first DL slot are determined as the guard period.

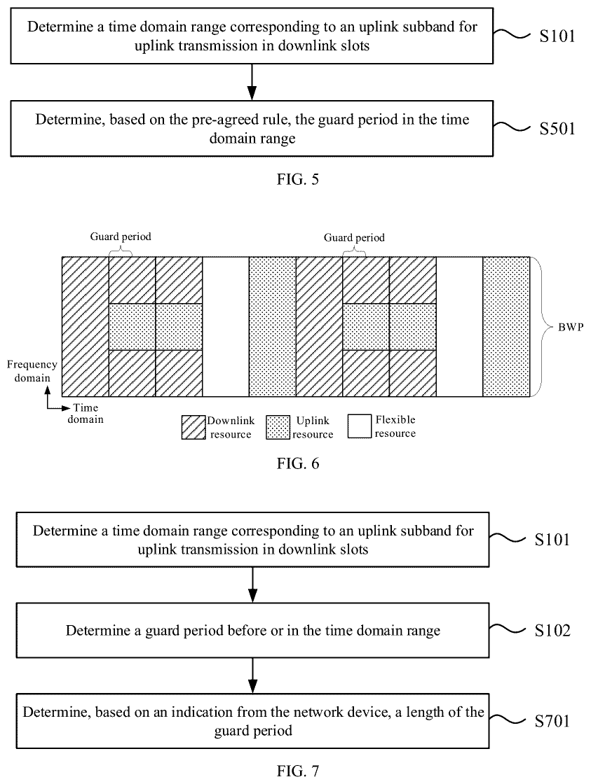

FIG. 5 is a schematic flowchart illustrating a guard period determination method according to yet another embodiment of the present disclosure. As shown in FIG. 5, after step S101 of FIG. 1, the determining the guard period before or in the time domain range (sS102) includes the following step S501.

At step S501, based on a pre-agreed/predetermined rule, the guard period is determined in the time domain range.

In an embodiment, the pre-agreed rule may be that the guard period is determined in the time domain resource corresponding to the UL subband.

For example, the time domain range corresponding to the UL subband starts from a first time domain symbol in the n-th DL slot, and the time domain range corresponding to the UL subband includes the n-th DL slot, thus the guard period can be determined in the n-th DL slot.

In an embodiment, the guard period includes at least one earlier time domain symbol in the time domain range, for example, from the first time domain symbol to the y-th time domain symbol in the time domain range, where y is an integer greater than or equal to 1.

FIG. 6 is a schematic diagram illustrating a plurality of time domains containing two frame structures, each with a guard period, according to another embodiment of the present disclosure.

As shown in FIG. 6, a frame structure is DDDSU, where D represents a DL slot, S represents a flexible slot, and U represents an UL slot. In three consecutive DL slots, the UL subband is configured in the second and third DL slots, and the time domain range corresponding to the UL subband starts from a first time domain symbol of the second DL slot.

The terminal, based on the pre-agreed rule, can determine the time domain range (such as the second DL slot) corresponding to the UL subband, thus can determine the guard period in the second DL slot, for example, N (N is a positive integer and can be indicated by the network device) earlier time domain symbols in the first DL slot are determined as the guard period.

In an embodiment, the method further includes: determining, based on an instruction from the network device, a starting slot in at least one downlink slot in which the uplink subband is located.

The network device may indicate to the terminal the starting slot in the at least one DL slot in which the UL subband is located, e.g. the network device may indicate an index of the starting slot, e.g. for a plurality of consecutive DL slots, the index is counted from 0. For example, in the case of three consecutive DL slots in the embodiment shown previously, the index indicated by the network device is 1, whereby the terminal can determine the starting slot in the DL slots in which the UL subband is located to be the second DL slot.

It is to be noted that the network device may indicate other information in addition to the starting slot, which may be set as required, for example, the network device may indicate the period of the UL subband, and in the case of three consecutive DL slots in the embodiment shown previously, the period may be two slots.

In all embodiments of the present disclosure, based on the pre-agreed rule, it can be determined whether the guard period is determined in the time domain range corresponding to the UL subband or before the time domain range corresponding to the UL subband. However, the length of the guard period, such as a number N of occupied time domain symbol, may be determined in other ways. The length of the guard period is exemplarily described below by means of several embodiments.

FIG. 7 is a schematic flowchart illustrating a guard period determination method according to yet another embodiment of the present disclosure. As shown in FIG. 7, the method shown in FIG. 1 further includes the following step S701.

At step S701, based on an indication from the network device, a length of the guard period is determined.

In an embodiment, the network device can indicate to the terminal the length of the guard period, for example, the network device indicates to the terminal the number N of time domain symbol occupied by the guard period.

The way in which the network device indicates the length of the guard period to the terminal includes, but is not limited to, a semi-static indication through radio resource control (RRC) signaling, and a dynamic indication through downlink control information (DCI) or media access control control element (MAC CE).

In an embodiment, the method further includes: transmitting to the network device switching capability information, for switching from downlink reception to uplink transmission, of the terminal.

In an embodiment, the terminal may switch the RF device from being used for downlink reception to being used for uplink transmission in the guard period.

In this case, the length of the guard period is mainly related to the length of time required for the terminal to switch from downlink reception to uplink transmission, and the length of time can be characterized by the switching capability information, for switching from downlink reception to uplink transmission, of the terminal. Accordingly, the terminal may transmit to the network device the switching capability information for switching from downlink reception to uplink transmission, so that the network device accurately determines the guard period based on the switching capability information, so as to avoid determining the guard period to be too small and causing the terminal to fail to complete the switching from downlink reception to uplink transmission in the guard period, as well as to avoid setting the guard period to be too large and wasting the time domain resources.

In an embodiment, the method further includes: transmitting to the network device information related to communication delay from the terminal to the network device.

In an embodiment, in the guard period, the terminal can compensate for the transmission delay (e.g., a delay from transmitting a signal by the network device to the reception of the signal by the terminal) between the network device and the terminal, and perform timing synchronization.

In this case, the length of the guard period is mainly related to the transmission delay between the terminal and the network device, therefore, the terminal may transmitting to the network device information related to communication delay from the terminal to the network device, so that the network device accurately determines the guard period based on information related to communication delay, so as to avoid determining the guard period to be too small and causing the terminal to fail to complete the compensation for the transmission delay in the guard period, as well as to avoid setting the guard period to be too large and wasting the time domain resources.

The information related to communication delay includes, but is not limited to, a distance from the terminal to the network device, a coverage range of the cell in which the terminal is located, and the like.

In an embodiment, the network device may determine the length of the guard period based on the switching capability information or the information related to communication delay, or the network device may determine the length of the guard period based on the switching capability information and the information related to communication delay. The specifics can be determined by the network device as needed.

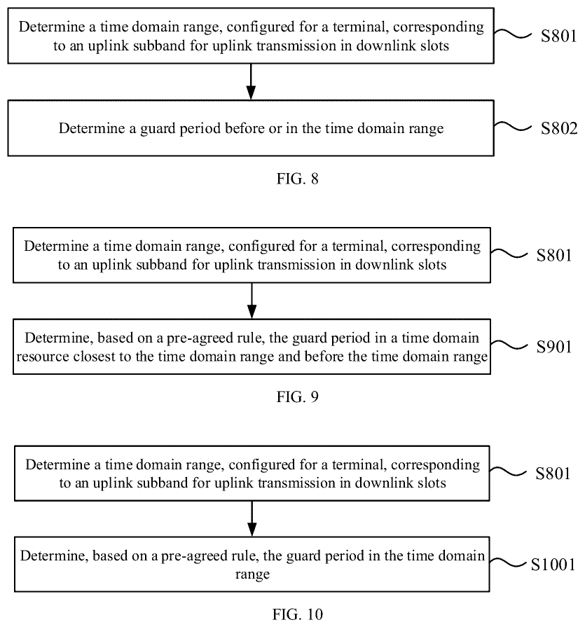

FIG. 8 is a schematic flowchart illustrating a guard period determination method according to an embodiment of the present disclosure. The guard period determination apparatus shown in this embodiment can be applied to a network device, which can communicate with a terminal. The network device includes, but is not limited to, a base station (such as a 4G base station, a 5G base station, a 6G base station and the like) in a communication system. The terminal includes, but is not limited to, a communication device such as a mobile phone, a tablet, a wearable device, a sensor, and an IoT device (e.g., NB-IoT, MTC, eMTC).

As shown in FIG. 8, the guard period determination method may include the following steps S801 and S802.

At step S801, a time domain range, configured for a terminal, corresponding to an uplink subband for uplink transmission in downlink slots is determined.

At step S802, a guard period is determined before or in the time domain range.

In an embodiment, duplex communication may be performed between the terminal and the network device, for example, full duplex communication may be performed, or half duplex communication may be performed.

The network device can configure the downlink (DL) slot for the terminal, and a frequency domain resource corresponding to the DL slot can include a frequency band or one or more bandwidth parts (BWPs) in a frequency band.

In an embodiment, the DL slot configured by the network device to the terminal may be a plurality of consecutive DL slots, some of the plurality of consecutive DL slots may be configured with a UL subband, so that there is a downlink time domain resource for downlink data reception before the time domain range corresponding to the UL subband.

For example, the time domain range corresponding to the UL subband starts from a first time domain symbol in a n-th (n is a positive integer) DL slot, and the time domain resource before the time domain range corresponding to the UL subband includes a (n−1)-th DL slot.

For example, the time domain range corresponding to the UL subband starts from a fifth time domain symbol in the n-th DL slot, and the time domain resource before the time domain range corresponding to the UL subband includes the first four time domain symbols in the n-th DL slot.

The time domain symbol is an orthogonal frequency division multiplexing (OFDM) symbol.

However, the terminal needs some time to switch the radio frequency (RF) device when switching from downlink reception to uplink transmission, otherwise it will bring interference to the uplink transmission. For example, the uplink transmission is performed after the downlink reception in the downlink time domain resource, if the switching of the RF device is not completed when the uplink transmission is required, the switching still needs to be completed before the terminal can perform the uplink transmission. This results in a delay in the timing of the uplink transmission, and thus causes interference to the uplink transmission.

According to the embodiments of the present disclosure, the terminal can determine the time domain range, configured by the network device, corresponding to the uplink subband for uplink transmission in downlink slots, and determine the guard period before or in the time domain range. The terminal does not expect to receive downlink data and does not transmit uplink data in the guard period, but may instead perform the switching from downlink reception to uplink transmission. Thus, ensuring that the terminal has completed the switching by the time the terminal needs to perform the uplink transmission, so that the terminal can perform the uplink transmission in a timely manner, and interference with the uplink transmission caused by the occurrence of a delay in the uplink transmission is avoided.

It is to be noted that the terminal and the network device may determine, based on a pre-agreed rule (for example, a protocol), the guard period before or in the time domain range, respectively, where the pre-agreed rule is known to both the network device and the terminal. Therefore, the terminal does not expect to receive downlink data and does not transmit uplink data in the guard period, and the network device does not expect to receive uplink data transmitted by the terminal and does not transmit downlink data to the terminal in the guard period. But the network device may receive uplink data transmitted by other terminals or transmit downlink data to other terminals in the guard period.

In an embodiment, the guard period is for the terminal to switch from downlink reception to uplink transmission. For example, the terminal may switch the RF device from being used for downlink reception to being used for uplink transmission in the guard period. However, it is to be noted that the operation performed by the terminal in the guard period is not limited to the switching from downlink to uplink, but other operations may be performed as required, such as performing operations such as compensating for the transmission delay (e.g., a delay from transmitting a signal by the network device to the reception of the signal by the terminal) between the network device and the terminal, performing timing synchronization, and the like.

In addition, it is to be noted that the UL subband applicable to the embodiments of the present disclosure includes an UL subband after a DL slot and adjacent to the DL slot, or an UL subband after a DL symbol and adjacent to the DL symbol. This is because the need to set the guard period is only necessary for the UL subband in this case.

FIG. 9 is a schematic flowchart illustrating a guard period determination method according to another embodiment of the present disclosure. As shown in FIG. 9, after step S801 in FIG. 8, the determining the guard period before or in the time domain range (S802) includes the following step S901.

At step S901, based on a pre-agreed/predetermined rule, the guard period is determined in a time domain resource closest to the time domain range and before the time domain range.

In an embodiment, the pre-agreed rule may be that the guard period is determined in the time domain resource closest to the time domain range and before the time domain range corresponding to the UL subband.

For example, the time domain range corresponding to the UL subband starts from a first time domain symbol in the n-th DL slot, and the time domain resource adjacent to the time domain range and before the time domain range corresponding to the UL subband includes the (n−1)-th DL slot, thus the guard period can be determined in the (n−1)-th DL slot.

In an embodiment, the guard period includes at least one time domain symbol in the time domain resource close to the time domain range, for example, from the last time domain symbol to the x-th to last time domain symbol in the time domain resource, where x is an integer greater than or equal to 1. Accordingly, the terminal may enter the guard period after performing the downlink reception in the time domain resource, and can perform the uplink transmission immediately after the guard period.

As shown in FIG. 4, a frame structure is DDDSU, where D represents a DL slot, S represents a flexible slot, and U represents an UL slot. In three consecutive DL slots, the UL subband is configured in the second and third DL slots, and the time domain range corresponding to the UL subband starts from a first time domain symbol of the second DL slot.

The terminal, based on the pre-agreed rule, can determine the time domain resource, such as the first DL slot, which is closest to the time domain range and before the time domain range corresponding to the UL subband, thus can determine the guard period in the first DL slot, for example, N (N is a positive integer and can be indicated by the network device) time domain symbols, close to the time domain range, in the first DL slot are determined as the guard period.

Correspondingly, the guard period determined by the network device based on the pre-agreed rule is the same as the guard period determined by the terminal, and in the guard period, the network device may not transmit downlink information to the terminal, nor expect to receive uplink information transmitted by the terminal. However, the network device can transmit downlink information to other terminals or receive uplink information from other terminals.

FIG. 10 is a schematic flowchart illustrating a guard period determination method according to yet another embodiment of the present disclosure. As shown in FIG. 10, after step S801 in FIG. 8, the determining the guard period before or in the time domain range (S802) includes the following step S1001.

At step S1001, based on a pre-agreed rule, the guard period is determined in the time domain range.

In an embodiment, the pre-agreed rule may be that the guard period is determined in the time domain resource corresponding to the UL subband.

For example, the time domain range corresponding to the UL subband starts from a first time domain symbol in the n-th DL slot, and the time domain range corresponding to the UL subband includes the n-th DL slot, thus the guard period can be determined in the n-th DL slot.

In an embodiment, the guard period includes at least one earlier time domain symbol in the time domain range, for example, from the first time domain symbol to the y-th time domain symbol in the time domain range, where y is an integer greater than or equal to 1.

As shown in FIG. 6, a frame structure is DDDSU, where D represents a DL slot, S represents a flexible slot, and U represents an UL slot. In three consecutive DL slots, the UL subband is configured in the second and third DL slots, and the time domain range corresponding to the UL subband starts from a first time domain symbol of the second DL slot.

The terminal, based on the pre-agreed rule, can determine the time domain range (such as the second DL slot) corresponding to the UL subband, thus can determine the guard period in the second DL slot, for example, N (N is a positive integer and can be indicated by the network device) earlier time domain symbols in the second DL slot are determined as the guard period.

Correspondingly, the guard period determined by the network device based on the pre-agreed rule is the same as the guard period determined by the terminal, and in the guard period, the network device may not transmit downlink information to the terminal, nor expect to receive uplink information transmitted by the terminal. However, the network device can transmit downlink information to other terminals or receive uplink information from other terminals.

In an embodiment, the method further includes: indicating to the terminal a starting slot in at least one downlink slot in which the uplink subband is located.

The network device may indicate to the terminal the starting slot in the at least one DL slot in which the UL subband is located, e.g. the network device may indicate an index of the starting slot, e.g. for a plurality of consecutive DL slots, the index is counted from 0. For example, in the case of three consecutive DL slots in the embodiment shown previously, the index indicated by the network device is 1, whereby the terminal can determine the starting slot in the DL slots in which the UL subband is located to be the second DL slot.

In all embodiments of the present disclosure, based on the pre-agreed rule, it can be determined whether the guard period is determined in the time domain range corresponding to the UL subband or before the time domain range corresponding to the UL subband. However, the length of the guard period, such as a number N of occupied time domain symbol, may be determined in other ways. The length of the guard period is exemplarily described below by means of several embodiments.

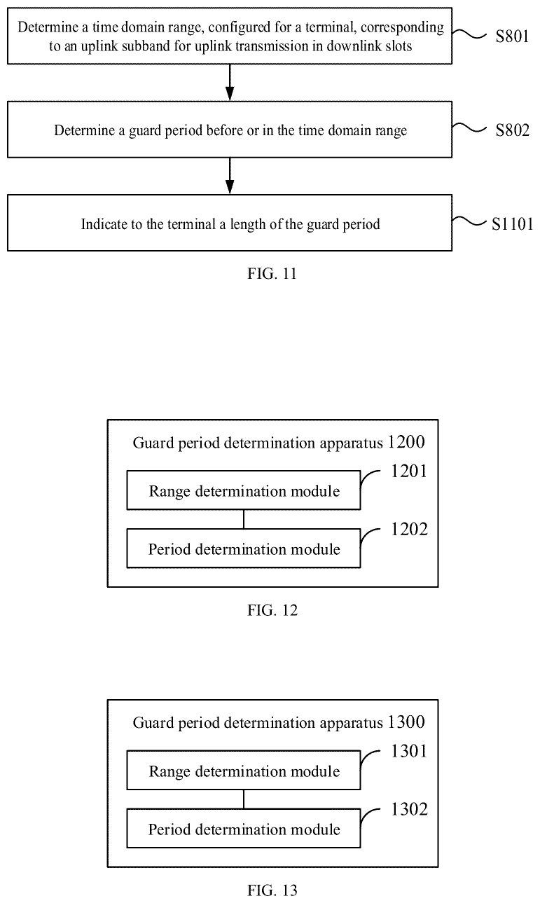

FIG. 11 is a schematic flowchart illustrating a guard period determination method according to yet another embodiment of the present disclosure. As shown in FIG. 11, the method of FIG. 8 further includes the following step S1101.

At step S1101, the network device indicates to the terminal a length of the guard period.

In an embodiment, the network device can indicate to the terminal the length of the guard period, for example, the network device indicates to the terminal the number N of time domain symbol occupied by the guard period.

The way of indication includes, but is not limited to, a semi-static indication through radio resource control (RRC) signaling, and a dynamic indication through downlink control information (DCI) or media access control control element (MAC CE).

In an embodiment, the method further includes: receiving switching capability information, for switching from downlink reception to uplink transmission, of the terminal transmitted by the terminal; and determining, based on the switching capability information, a length of the guard period.

In an embodiment, the terminal may switch the RF device from being used for downlink reception to being used for uplink transmission in the guard period.

In this case, the length of the guard period is mainly related to the length of time required for the terminal to switch from downlink reception to uplink transmission, and the length of time can be characterized by the switching capability information, for switching from downlink reception to uplink transmission, of the terminal. Accordingly, the terminal may transmit to the network device the switching capability information for switching from downlink reception to uplink transmission, so that the network device accurately determines the guard period based on the switching capability information, so as to avoid determining the guard period to be too small and causing the terminal to fail to complete the switching from downlink reception to uplink transmission in the guard period, as well as to avoid setting the guard period to be too large and wasting the time domain resources.

In an embodiment, the method further includes: determining information related to communication delay from the terminal to the network device; and determining, based on the information related to communication delay, a length of the guard period.

In an embodiment, in the guard period, the terminal can compensate for the transmission delay (e.g., a delay from transmitting a signal by the network device to the reception of the signal by the terminal) between the network device and the terminal, and perform timing synchronization.

In this case, the length of the guard period is mainly related to the transmission delay between the terminal and the network device, so that the network device may determine the information related to the communication delay from the terminal to the network device, for example, the information related to the communication delay determined by the terminal may be transmitted to the network device by the terminal, or the network device autonomously determines the information related to the communication delay. Therefore, the guard period can be accurately determined based on information related to communication delay, so as to avoid determining the guard period to be too small and causing the terminal to fail to complete the compensation for the transmission delay in the guard period, as well as to avoid setting the guard period to be too large and wasting the time domain resources.

The information related to communication delay includes, but is not limited to, a distance from the terminal to the network device, a coverage range of the cell in which the terminal is located, and the like.

In an embodiment, the network device may determine the length of the guard period based on the switching capability information or the information related to communication delay, or the network device may determine the length of the guard period based on the switching capability information and the information related to communication delay. The specifics can be determined by the network device as needed.

Corresponding to the foregoing embodiments of the guard period determination method, the present disclosure also provides embodiments of a guard period determination apparatus.

FIG. 12 is a schematic block diagram illustrating a guard period determination apparatus 1200 according to an embodiment of the present disclosure. The guard period determination apparatus 1200 shown in this embodiment may be applied to a terminal. The terminal includes, but is not limited to, a communication device such as a cell phone, a tablet, a wearable device, a sensor, an internet of things (IoT) device, and the like. The terminal may communicate with a network device. The network device includes, but is not limited to a network device (such as a base station, a core network, and the like) in a communication system such as a 4th generation (4G) communication system, 5G communication system, 6G communication system, etc.

As shown in FIG. 12, the guard period determination apparatus 1200 may include a range determination module 1201, and a period determination module 1202.

The range determination module 1201 is configured to determine a time domain range corresponding to an uplink subband for uplink transmission in downlink slots.

The period determination module 1202 is configured to determine a guard period before or in the time domain range.

In an embodiment, the guard period is for the terminal to switch from downlink reception to uplink transmission.

In an embodiment, the period determination module 1202 is configured to determine, based on the pre-agreed rule, the guard period in a downlink time domain resource closest to the time domain range and before the time domain range.

In an embodiment, the guard period includes at least one time domain symbol, close to the time domain range, in the time domain resource.

In an embodiment, the period determination module 1202 is configured to determine, based on the pre-agreed rule, the guard period in the time domain range.

In an embodiment, the guard period includes at least one time domain symbol early in the time domain range.

In an embodiment, the guard period determination apparatus 1200 further includes a length determination module (not shown), configured to determine, based on an indication from the network device, a length of the guard period.

In an embodiment, the guard period determination apparatus 1200 further includes a transmitting module (not shown), which is configured to transmit to the network device switching capability information, for switching from downlink reception to uplink transmission, of the terminal.

In an embodiment, the guard period determination apparatus 1200 further includes a transmitting module (not shown), which is configured to transmit to the network device information related to communication delay from the terminal to the network device.

In an embodiment, the guard period determination apparatus 1200 further includes a transmitting module (not shown), which is configured to determine, based on an instruction from the network device, a starting slot in at least one downlink slot in which the uplink subband is located.

FIG. 13 is a schematic block diagram illustrating a guard period determination apparatus 1300 according to an embodiment of the present disclosure. The guard period determination apparatus 1300 shown in this embodiment can be applied to a network device, which can communicate with a terminal. The network device includes, but is not limited to, a base station (such as a 4G base station, a 5G base station, a 6G base station and the like) in a communication system. The terminal includes, but is not limited to, a communication device such as a mobile phone, a tablet, a wearable device, a sensor, and an IoT device (e.g., NB-IoT, MTC, eMTC).

As shown in FIG. 13, the guard period determination apparatus 1300 may include a range determination module 1301, and a period determination module 1302.

The range determination module 1301 is configured to determine a time domain range, configured for a terminal, corresponding to an uplink subband for uplink transmission in downlink slots.

The period determination module 1302 is configured to determine a guard period before or in the time domain range.

In an embodiment, the guard period is for the terminal to switch from downlink reception to uplink transmission.

In an embodiment, the period determination module 1302 is configured to determine, based on the pre-agreed rule, the guard period in a downlink time domain resource closest to the time domain range and before the time domain range.

In an embodiment, the guard period includes at least one time domain symbol, close to the time domain range, in the time domain resource.

In an embodiment, the period determination module 1302 is configured to determine, based on the pre-agreed rule, the guard period in the time domain range.

In an embodiment, the guard period includes at least one time domain symbol early in the time domain range.

In an embodiment, the guard period determination apparatus 1300 further includes a transmitting module (not shown), configured to indicate to the terminal a length of the guard period.

In an embodiment, the guard period determination apparatus 1300 further includes: a receiving module (not shown), configured to receive switching capability information, for switching from downlink reception to uplink transmission, of the terminal transmitted by the terminal; and a length determination module, configured to determine, based on the switching capability information, a length of the guard period.

In an embodiment, the guard period determination apparatus 1300 further includes: a delay determination module (not shown), configured to determine information related to communication delay from the terminal to the network device; and a length determination module, configured to determine, based on the information related to communication delay, a length of the guard period.

In an embodiment, the guard period determination apparatus 1300 further includes a transmitting module (not shown), configured to indicate to the terminal a starting slot in at least one downlink slot in which the uplink subband is located.

With regard to the devices in the examples, the specific manner in which the respective modules perform the operations has been described in detail in the examples of the related methods, and will not be explained in detail herein.

Since the embodiments of the apparatus substantially corresponds to the embodiments of the method, relevant parts may be referred to the description of the embodiments of the method. The apparatus examples described are merely illustrative, where the modules described as separate members may be or not be physically separated, and the members displayed as modules may be or not be physical units, i.e., may be located in one place, or may be distributed in a plurality of network modules. Part or all of the modules may be selected according to actual requirements to implement the objectives of the solutions in the examples. It may be understood and implemented by those skilled in the art without creative work.

The embodiments of the present disclosure provide a communication device, including: a processor; and a memory storing computer programs, where the computer programs, when executed by the processor, cause the processor to perform the guard period determination method which is applicable to a terminal, such as the guard period determination apparatus 1200.

The embodiments of the present disclosure provide a communication device, including: a processor; and a memory storing computer programs, where the computer programs, when executed by the processor, cause the processor to perform the guard period determination method which is applicable to a network device, such as the guard period determination apparatus 1300.

The embodiments of the present disclosure provide a non-transitory computer-readable storage medium, storing computer programs thereon, where the computer programs, when executed by a processor, cause the processor to perform the guard period determination method which is applicable to a terminal.

The embodiments of the present disclosure provide a non-transitory computer-readable storage medium, storing computer programs thereon, where the computer programs, when executed by a processor, cause the processor to perform the guard period determination method which is applicable to a network device.

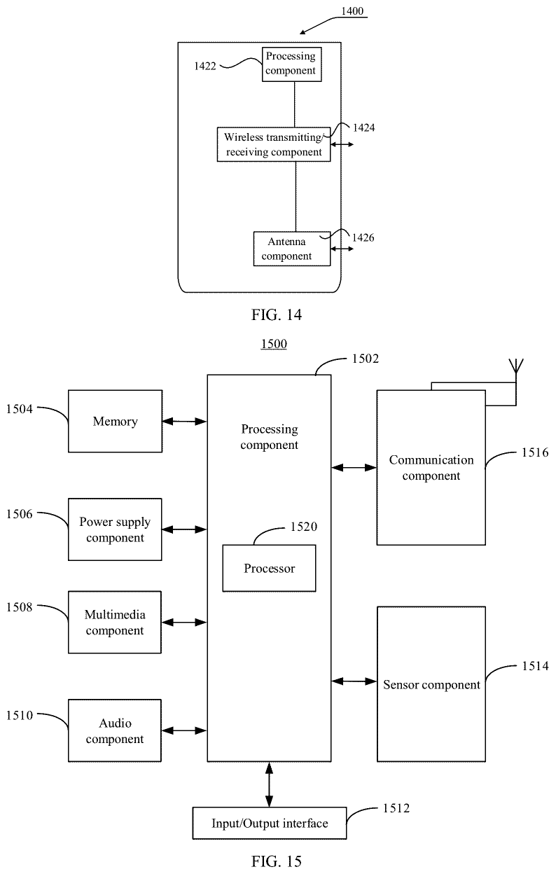

FIG. 14 is a schematic block diagram illustrating a device 1400 for determining a guard period according to an embodiment of the present disclosure. The device 1400 may be provided as a base station (network device). Referring to FIG. 14, the device 1400 includes a processing component 1422, a wireless transmitter/receiver component 1424, an antenna component 1426, and a signal processing portion (not shown in the figures) specific to a wireless interface. The processing component 1422 may further include one or more processors. One of the processors in the processing component 1422 may be configured to perform the guard period determination method applicable to a network device in any one of the embodiments.

FIG. 15 is a schematic block diagram illustrating a device 1500 for determining a guard period according to an embodiment of the present disclosure. For example, the device 1500 can be a mobile phone, a computer, a digital broadcast terminal, a message transmitting and receiving device, a gaming console, a tablet device, a medical device, a fitness device, a personal digital assistant, and the like (a terminal).

Referring to FIG. 15, the device 1500 can include one or more of the following components: a processing component 1502, a memory 1504, a power supply component 1506, a multimedia component 1508, an audio component 1510, an input/output (I/O) interface 1512, a sensor component 1514, and a communication component 1516.

The processing component 1502 controls overall operations of the device 1500, such as operations related to display, a telephone call, data communication, a camera operation and a record operation. The processing component 1502 may include one or more processors 1520 to execute instructions to complete all or a part of the steps of the guard period determination method applicable to a terminal. Further, the processing component 1502 may include one or more modules to facilitate interaction between the processing component 1502 and another component. For example, the processing component 1502 may include a multimedia module to facilitate the interaction between the multimedia component 1508 and the processing component 1502.

The memory 1504 is configured to store different types of data to support the operations of the device 1500. Examples of such data include instructions, contact data, phone book data, messages, pictures, videos, and so on for any application or method that operates on the device 1500. The memory 1504 may be implemented by any type of volatile or non-volatile storage device or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a disk or optical disk.

The power supply component 1506 provides power for different components of the device 1500. The power supply component 1506 may include a power management system, one or more power sources, and other components associated with generating, managing and distributing power for the device 1500.

The multimedia component 1508 includes a screen for providing an output interface between the device 1500 and a user. In some embodiments, the screen may include a liquid crystal display (LCD) and/or a touch panel (TP). If the screen includes a touch panel, the screen may be implemented as a touch screen for receiving an input signal from a user. The touch panel may include one or more touch sensors for sensing a touch, a slide and a gesture on the touch panel. The touch sensor may not only sense a boundary of a touching or sliding movement, but also detect duration and pressure related to the touching or sliding operation. In some examples, the multimedia component 1508 may include a front camera and/or a rear camera. When the device 1500 is in an operation mode, such as a shooting mode or a video mode, the front camera and/or the rear camera can receive external multimedia data. Each of the front camera and the rear camera may be a fixed optical lens system or be of a focal length and a capability of an optical zoom.

The audio component 1510 is configured to output and/or input an audio signal. For example, the audio component 1510 may include a microphone (MIC). When the device 1500 is in an operating mode, such as a call mode, a recording mode and a speech recognition mode, the microphone is configured to receive an external audio signal. The received audio signal may be further stored in the memory 1504 or sent via the communication component 1516. In some embodiments, the audio component 1510 also includes a speaker for outputting an audio signal.

The I/O interface 1512 provides an interface between the processing component 1502 and a peripheral interface module which may be a keyboard, a click wheel, a button, or the like. Such buttons may include but not limited to: a home button, a volume button, a start button and a lock button.

The sensor component 1514 includes one or more sensors for providing state assessments in different aspects for the device 1500. For example, the sensor component 1514 can detect an open/closed state of the device 1500, a relative positioning of components, such as the display and keypad of the device 1500, and sensor component 1514 can also detect a change in position of the device 1500 or a component of the device 1500, the presence or absence of user contact with the device 1500, orientation or acceleration/deceleration of the device 1500, and temperature change of the device 1500. The sensor component 1514 may include a proximity sensor configured to detect presence of a nearby object without any physical contact. The sensor component 1514 may also include an optical sensor, such as a CMOS or CCD image sensor used in an imaging application. In some examples, the sensor component 1514 may also include an acceleration sensor, a gyro sensor, a magnetic sensor, a pressure sensor, or a temperature sensor.

The communication component 1516 is configured to facilitate wired or wireless communication between the device 1500 and other devices. The device 1500 may access a wireless network based on a communication standard, such as WiFi, 2G, 3G, 4G LTE, 5G NR, or a combination thereof. In some embodiments, the communication component 1516 may receive a broadcast signal or broadcast-related information from an external broadcast management system via a broadcast channel. In an example, the communication component 1516 may also include a near field communication (NFC) module to facilitate short-range communications. For example, the NFC module may be implemented based on a radio frequency identification (RFID) technology, an infrared data association (IrDA) technology, an ultra wide band (UWB) technology, a Bluetooth (BT) technology, and other technologies.

In an exemplary example, device 1500 may be implemented by one or more application specific integrated circuits (ASICs), digital signal processors (DSPs), digital signal processing devices (DSPDs), programmable logic devices (PLDs), field programmable gate array (FPGA), controller, microcontroller, microprocessor or other electronic elements for performing the guard period determination method applicable to a terminal in any of the above examples.

In an embodiment, a non-transitory computer readable storage medium including instructions, such as the memory 1504 including instructions, is also provided. The above instructions may be executed by the processor 1520 of the device 1500 to complete the guard period determination method applicable to a terminal. For example, the non-transitory computer readable storage medium may be a read-only memory (ROM), a random access memory (RAM), a CD-ROM, a magnetic tape, a floppy disk and an optical data storage device, etc.

After considering the specification and practicing the present disclosure, the persons of skill in the prior art may easily conceive of other implementations of the present disclosure. The present disclosure is intended to cover any variations, uses, modification or adaptations of the present disclosure that follow the general principles thereof and include common knowledge or conventional technical means in the art that are not disclosed in the present disclosure. The specification and examples are considered as exemplary only, with a true scope and spirit of the present disclosure being indicated by the claims.

It is to be understood that the present disclosure is not limited to the precise construction described herein and shown in the drawings, and that various modifications and changes may be made without departing from the scope thereof. The scope of the disclosure is to be limited only by the appended claims.

It shall be noted that the relational terms such as “first” and “second” used herein are merely intended to distinguish one entity or operation from another entity or operation rather than to require or imply any such actual relation or order existing between these entities or operations. Also, the term “including”, “containing” or any variation thereof is intended to encompass non-exclusive inclusion, so that a process, method, article or device including a series of elements includes not only those elements but also other elements not listed explicitly or those elements inherent to such a process, method, article or device. Without more limitations, an element defined by the statement “including a . . . ” shall not be precluded to include additional same elements present in a process, method, article or device including the elements.

The methods and apparatuses of the present disclosure are described herein in detail. The principle and implementation of the present disclosure are described herein through specific examples. The description about the embodiments of the present disclosure is merely provided for ease of understanding of the method and core ideas of the present disclosure. Persons of ordinary skill in the art can make variations and modifications to the present disclosure in terms of the specific implementations and application scopes according to the ideas of the present disclosure. Therefore, the specification shall not be construed as a limit to the present disclosure.

1. A guard period determination method, performed by a terminal, comprising:
determining a time domain range corresponding to an uplink subband for uplink transmission in downlink slots; and
determining a guard period before or in the time domain range.

2. The method of claim 1, wherein the guard period is for the terminal to switch from downlink reception to the uplink transmission.

3. The method of claim 1, wherein determining the guard period before or in the time domain range comprises:
determining, based on a pre-agreed rule, the guard period in a time domain resource closest to a start of the time domain range and before the start of the time domain range; or
determining, based on a pre-agreed rule, the guard period in the time domain range.

4. The method of claim 3, wherein
the guard period comprises at least one time domain symbol, close to the start of the time domain range, in the time domain resource; or
the guard period comprises at least one time domain symbol in the time domain range and close to the start of the time domain range.

5.-6. (canceled)

7. The method of claim 1, further comprising:
determining, based on an indication from a network device, a length of the guard period.

8. The method of claim 7, further comprising:
transmitting to the network device switching capability information, for switching from downlink reception to the uplink transmission, of the terminal.

9. The method of claim 7, further comprising:
transmitting to the network device information related to a communication delay from the terminal to the network device.

10. The method of claim 1, further comprising:
determining, based on an indication from a network device, a starting slot for the uplink subband in the downlink slots.

11. A guard period determination method, performed by a network device, comprising:
determining a time domain range, configured for a terminal, corresponding to an uplink subband for uplink transmission in downlink slots; and
determining a guard period before or in the time domain range.

12. The method of claim 11, wherein the guard period is for the terminal to switch from downlink reception to the uplink transmission.

13. The method of claim 11, wherein determining the guard period before or in the time domain range comprises:
determining, based on a pre-agreed rule, the guard period in a time domain resource closest to a start of the time domain range and before the start of the time domain range; or determining, based on a pre-agreed rule, the guard period in the time domain range.

14. The method of claim 13, wherein
the guard period comprises at least one time domain symbol, close to the start of the time domain range, in the time domain resource; or
the guard period comprises at least one time domain symbol in the time domain range and close to the start of the time domain range.

15.-16. (canceled)

17. The method of claim 11, further comprising:
indicating to the terminal a length of the guard period.

18. The method of claim 17, further comprising:
receiving switching capability information, for switching from downlink reception to the uplink transmission, of the terminal transmitted by the terminal; and
determining, based on the switching capability information, the length of the guard period.

19. The method of claim 17, further comprising:
determining information related to a communication delay from the terminal to the network device; and
determining, based on the information related to the communication delay, the length of the guard period.

20. The method of claim 11, further comprising:
indicating to the terminal a starting slot for the uplink subband in the downlink slots.

21.-22. (canceled)

23. A communication device, comprising:
a processor; and
a memory storing computer programs,
wherein the computer programs, when executed by the processor, cause the processor to perform operations comprising:
determining a time domain range corresponding to an uplink subband for uplink transmission in downlink slots; and
determining a guard period before or in the time domain range.

24. A communication device, comprising:
a processor; and
a memory storing computer programs,
wherein the computer programs, when executed by the processor, cause the processor to perform the guard period determination method according to claim 11.

25. A non-transitory computer-readable storage medium, storing computer programs thereon, wherein the computer programs, when executed by a processor, cause the processor to perform the guard period determination method according to claim 1.

26. A non-transitory computer-readable storage medium, storing computer programs thereon, wherein the computer programs, when executed by a processor, cause the processor to perform the guard period determination method according to claim 11.
